(19) United States
(12) Patent Application Publication
(10) Pub. No.: US 2011/0246025 A1
(43) Pub. Date: Oct. 6, 2011

(54) Vehicle position tracking system

(75) Inventor: Toshiro Ishihara, Kariya-city (JP)

(73) Assignee: DENSO CORPORATION, Kariya-city (JP)

(21) Appl. No.: 13/065,506

(22) Filed: Mar. 23, 2011

(30) Foreign Application Priority Data
Apr. 6, 2010 (JP) 2010-88109

(51) Int. Cl. G06F 7/00

(52) U.S. Cl. 701/36

(57) ABSTRACT

A vehicle position tracking system includes: an in-vehicle device; and a center device. The in-vehicle device includes: a GPS detector for detecting a vehicle position; an environmental information obtaining element for obtaining environmental information having detection data; a communication element for communicating with the center device; and a controller for controlling the communication element to transmit the environmental information when reception of a GPS signal via the GPS detector is interrupted. The center device includes: a communication information obtaining element for obtaining the environmental information from the in-vehicle device; a database for obtaining observation information having observation data; and an estimation unit for estimating a moving route of the vehicle based on the environmental information such that the estimation unit arranges multiple observation position data corresponding to multiple retrieved observation data in a chronological order. The estimation unit retrieves multiple observation data corresponding to multiple detection data.

### CROSS REFERENCE TO RELATED APPLICATION

This application is based on Japanese Patent Application No. 2010-88109 filed on Apr. 6, 2010, the disclosure of which is incorporated herein by reference.

### TECHNICAL FIELD

The present invention relates to a vehicle position tracking system for tracking a position of a vehicle based on information transmitted from an in-vehicle device to an information center via a mobile communication network.

### BACKGROUND

Conventionally, a system is well known such that an emergency center such as a monitoring center monitors a state of a stolen vehicle when the vehicle is stolen. The system includes an in-vehicle device mounted on the vehicle for transmitting information relating to the vehicle, and an information center device mounted in a monitoring center for obtaining information transmitted from the in-vehicle device via a mobile communication network.

JP-A-2003-226228 teaches a stolen vehicle tracking device, which is mounted on the vehicle. A control circuit in the stolen vehicle tracking device receives a GPS (global positioning system) signal from a GPS satellite via a GPS receiver, so that the circuit detects the current position of the vehicle. Thus, the device collects positioning information. The control circuit transmits the positioning information to the mobile communication network with using a radio communication device. The information center device mounted in the monitoring center obtains the positioning information from the stolen vehicle tracking device via the mobile communication network. Thus, the information center device checks the position of the stolen vehicle continuously. Further, the information center device records a moving route of the stolen vehicle.

JP-B2-3723837 teaches a theft warning device for warning theft of the vehicle so that the information center device surely recognizes that the vehicle is stolen. The theft warning device includes a vehicle position detector for detecting a current position of the vehicle based on the GPS signal from the GPS satellite and a communication device for communicating with the information center device. For example, the theft warning device starts to execute a theft warning process based on information such as a fact that a door of the vehicle is locked. The theft warning device transmits positioning information of the vehicle to the monitoring center. The positioning information is detected by a current position detector.

Under a condition that the theft warning device starts to perform the theft warning process, if the stolen vehicle is accommodated in a container of a trailer, the theft warning device cannot receive the GPS signal with using the position detector. Accordingly, the theft warning device cannot detect the current position of the vehicle. The monitoring center stops receiving the positioning information from the in-vehicle device. Accordingly, the monitoring, center can recognize that the vehicle is stolen based on the positioning information transmitted from the in-vehicle device.

Here, the GPS signal has a weak power. Specifically, when the stolen vehicle is accommodated in the container, it is difficult to detect the position of the vehicle based on the GPS signal from the GPS satellite. On the other hand, communication between the in-vehicle device and the mobile communication network is performed with using a signal having a comparatively high power, compared with the GPS signal. Accordingly, even if the GSP positioning device cannot detect the position of the vehicle, it may be possible to communicate between the communication device in the vehicle and the mobile communication network.

In the stolen vehicle tracking device, when the device cannot receive the GPS signal with using the GPS positioning device, the in-vehicle device cannot transmit the information about the position of the vehicle to the mobile communication network. Accordingly, the information center device cannot estimate the moving route of the vehicle based on the information transmitted from the in-vehicle device.

### SUMMARY

In view of the above-described problem, it is an object of the present disclosure to provide a vehicle position tracking system for tracking a position of a vehicle and for estimating a moving route of the vehicle even if the system cannot detect the position of the vehicle with using a GPS position detector.

According to an aspect of the present disclosure, a vehicle position tracking system for tracking a position of a vehicle includes: an in-vehicle device mounted on the vehicle; and a center device mounted in an external center. The in-vehicle device transmits information to the center device via a mobile communication network so that the center device tracks the position of the vehicle. The in-vehicle device includes: a GPS detector for detecting a vehicle position of the vehicle based on a GPS signal from a GPS satellite; an environmental information obtaining element for obtaining environmental information, which includes a plurality of meteorological data of an outside of the vehicle as detection data and a plurality of detection time data, wherein each meteorological data corresponds to a respective detection time data; a communication element for communicating with the mobile communication network; and a controller for controlling the communication element to transmit the environmental information when reception of the GPS signal via the GPS detector is interrupted. The center device includes: a communication information obtaining element for obtaining the environmental information from the in-vehicle device via the mobile communication network; a database for obtaining observation information and for storing the observation information at every time when the database obtains the observation information, wherein the observation information includes a plurality of meteorological data observed at each of a plurality of observation points as observation data, a plurality of observation time data and observation position data of a respective observation point, and wherein each meteorological data at a respective observation point corresponds to a respective observation time data; and an estimation unit for estimating a moving route of the vehicle based on the environmental information. The estimation unit retrieves a plurality of observation data with a plurality of observation time data in such a manner that each observation data corresponds to respective detection data, each observation time data corresponds to respective detection time data. The estimation unit arranges a plurality of observation position data corresponding to a plurality of retrieved observation data in a chronological order so that the estimation unit estimates the moving route of the vehicle.

In the above system, even when the GPS detector cannot receive the GPS signal so that the GPS detector does not detect the position of the vehicle, if the communication between the communication element and the mobile communication network is possible, the in-vehicle device transmits the environmental information to the mobile communication network. The center device can estimate the moving route of the vehicle based on the environmental information. Accordingly, even when the GPS detector cannot detect the position of the vehicle, the system can track the position of the vehicle with using the estimated moving route of the vehicle.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram showing an in-vehicle device in a vehicle position tracking system according to an example embodiment;

FIG. 2 is a diagram showing a center device in the vehicle position tracking system;

FIG. 3 is a diagram showing contents of information about environmental conditions around the vehicle to be transmitted by the in-vehicle device;

FIG. 4 is a diagram showing contents of observation information stored in a database of the center device;

FIG. 5 is a flowchart showing a control process of theft determination executed by the in-vehicle device;

FIG. 6 is a flowchart showing a control process for transmitting environmental condition information executed by the in-vehicle device;

FIG. 7 is a flowchart showing a control process for estimating a moving route of the vehicle executed by the center device;

FIG. 8 is a flowchart showing another control process for transmitting environmental condition information executed by the in-vehicle device according to a modification of the example embodiment; and

FIG. 9 is a flowchart showing another control process for estimating a moving route of the vehicle executed by the center device according to a modification of the example embodiment.

### DETAILED DESCRIPTION

### First Embodiment

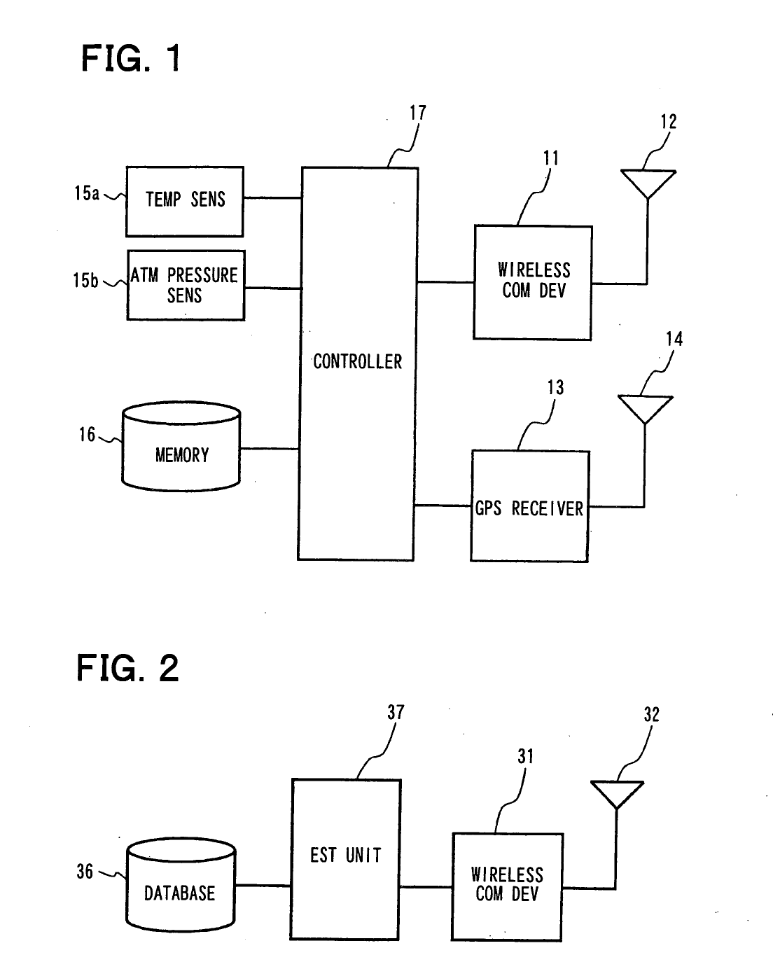

A vehicle position tracking system according to the present embodiment includes an in-vehicle device 10 shown in FIG. 1 and a center device 30 shown in FIG. 2. The system tracks a position of a stolen vehicle when the vehicle is stolen. The in-vehicle device 10 and the center device 30 will be explained as follows.

As shown in FIG. 1, the in-vehicle device 10 mounted on the vehicle includes a controller 17, a GPS receiver 13, a GPS antenna 14, a wireless communication device 11, a wireless antenna 12, a memory 16, a temperature sensor 15a and an atmospheric pressure sensor 15b.

The controller 17 includes a ROM for storing a program and the like and a RAM for functioning as a working area of calculation. The program provides various calculation processes. The controller 17 executes various processes based on signals from the wireless communication device 11 and the GPS receiver 13.

The GPS receiver 13 and the GPS antenna 14 detect the current position of the vehicle, on which the in-vehicle device 10 is mounted. The GPS receiver 13 receives the GPS signals via the GPS antenna 14. The GPS signals are transmitted from multiple GPS satellites (not shown). The GPS receiver 13 detects a latitude and a longitude of the current position of the vehicle, a movement of the vehicle and an altitude of the vehicle based on the GPS signals. The positioning information of the vehicle is output from the GPS receiver 13 to the controller 17.

The wireless communication device 11 and the wireless antenna 12 perform bi-directional communication between the mobile communication network such as a cell phone network and the in-vehicle device 10. The wireless communication device 11 and the wireless antenna 12 modulate a signal input from the controller 17, and then, the wireless communication device 11 and the wireless antenna 12 transmit an electric wave corresponding to the modulated signal to multiple base stations in the mobile communication network. The wireless communication device 11 and the wireless antenna 12 receives an electric wave transmitted from the base station, and then, the wireless communication device 11 and the wireless antenna 12 modulate the received electric wave, and input the modulated signal to the controller 17. In the first embodiment, the mobile communication network is a cell phone network. Alternatively, the mobile communication network may be various wireless communication means such as a public wireless LAN system and a local area communication system so that the in-vehicle device 10 transmits information to the wireless communication.

The memory 16 is a non-volatile memory such as a flash memory so that information is read out from the memory 16 and is written in the memory 16. The memory 16 stores vehicle environmental information obtained by the controller 17. Further, in the first embodiment, a communication record is stored in the memory 16. The communication record shows whether the vehicle environmental information is already transmitted to the mobile communication network by the wireless communication device 11 and the wireless antenna 12.

The temperature sensor 15a and the atmospheric pressure sensor 15b are sensors for detecting meteorological conditions. The temperature sensor 15a detects temperature in the out side of the vehicle, and the atmospheric pressure sensor 15b detects atmospheric pressure in the out side of the vehicle. The temperature sensor 15a and the atmospheric pressure sensor 15b are mounted on the in-vehicle device 10 as a part of the in-vehicle device 10. The temperature data and the atmospheric pressure data detected by the temperature sensor 15a and the atmospheric pressure sensor 15b are input into the controller 17. Each of the temperature sensor 15a and the atmospheric pressure sensor 15b is electrically coupled with the controller 17.

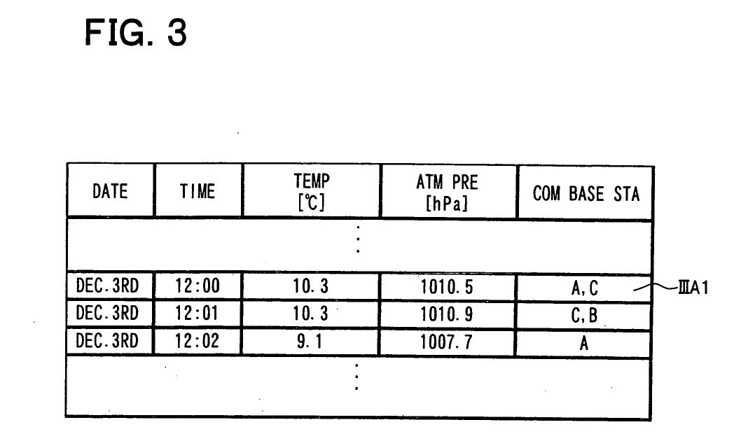

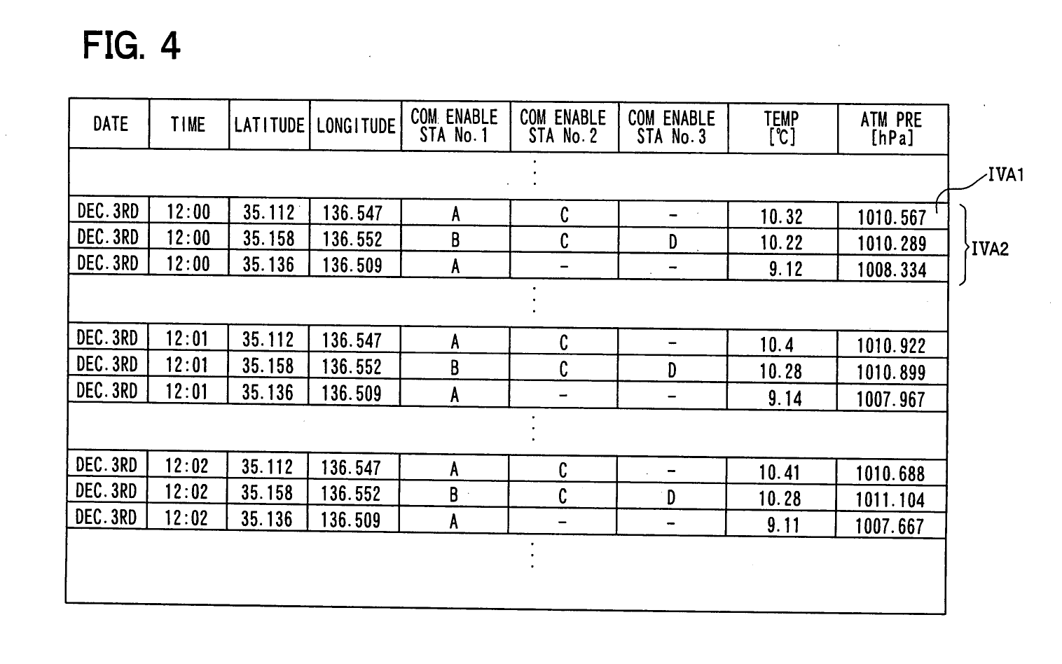

Thus, the controller 17 determines whether the detection of the current position of the vehicle is possible with using the GPS receiver 13 and the GPOS antenna 14. The controller 17 obtains the temperature data and the atmospheric pressure data detected by the temperature sensor 15a and the atmospheric pressure sensor 15b as the vehicle environmental information. The vehicle environmental information includes detection time of the temperature data and the atmospheric pressure data, at which the temperature data and the atmospheric pressure data are detected. Thus, as shown in FIG. 3, the vehicle environmental information includes the temperature data and the atmospheric pressure data as the detection data and the detection time data corresponding to the temperature data and the atmospheric pressure data.

The vehicle environmental information obtained by the controller 17 is stored in the memory 16 at every time when the vehicle environmental information is input into the controller 17. Thus, the vehicle environmental information is stored in the memory 16 according to the detection time. In addition, under a condition that the wireless communication device 11 can communicate with the mobile communication network, the vehicle environmental information is transmitted to the mobile communication network via the wireless communication device 11 and the wireless antenna 12. Under a condition that the wireless communication device 11 cannot communicate with the mobile communication network, the vehicle environmental information is stored in the memory 16 successively. In this case, when the wireless communication device 11 becomes to communicate with the mobile communication network, the vehicle environmental information stored in the memory 16 together with latest vehicle environmental information is transmitted to the mobile communication network via the wireless communication device 11.

As shown in FIG. 2, the center device 30 is disposed on the outside of the vehicle. The center device 30 is mounted in an emergency organization such as a monitoring center. The center device 30 includes an estimation unit 37, a wireless communication device 31, a wireless antenna 32 and a database 36, as shown in FIG. 2.

The estimation unit 37 is a functional unit of a calculation device having a ROM and a RAM. The ROM stores a program and the like. The RAM functions as a working area of calculation. The program provides various calculation processes. The estimation unit 37 executes the program stored in the ROM so that the estimation unit 37 performs a function. The estimation unit 37 performs various processes based on signals from the wireless communication device 31.

The wireless communication device 31 and the wireless antenna 32 perform bi-directional communication between the mobile communication network such as the cell phone network and the center device 30. The wireless communication device 31 and the wireless antenna 32 modulate a signal input from the estimation unit 37, and then, the wireless communication device 31 and the wireless antenna 32 transmit an electric wave corresponding to the modulated signal to multiple base stations in the mobile communication network. The wireless communication device 31 and the wireless antenna 32 receives an electric wave transmitted from the base station, and then, the wireless communication device 13 and the wireless antenna 32 modulate the received electric wave, and input the modulated signal to the estimation unit 37. The wireless communication device 31 and the wireless antenna 32 obtain the vehicle environmental information from the in-vehicle device 10 via the mobile communication network. Further, the observation information to be stored in the database 36 is obtained from a database in an external metrological organization.

In the first embodiment, the wireless communication device 31 and the wireless antenna 32 is used as a communication means for obtaining the information. Alternatively, the center device 30 may include an interface for wired communication so that the center device 30 obtains information from a wired communication network via the interface.

The database 36 is a data storage having a sufficient storage capacity. The database 36 stores the observation information transmitted from the database of the external metrological organization via the wireless communication device 31 and the wireless antenna 32. Here, the observation information is observed at various observation points. The database 36 stores the observation information at every time when the center device 30 obtains the information. The observation information includes temperature data, atmospheric pressure data, observation time and date at which the observation data is observed, and position data relating to the latitude and the longitude of the observation point. An observation device is mounted at each observation point, and the observation device observes the temperature, the atmospheric pressure and the like. Further, the estimation unit 37 attaches data about the communication enable base station to the observation information when the observation information is stored in the database 36, the communication enable base station being capable, of communicating with the wireless communication device 11 of the in-vehicle device 10 from the observation point corresponding to the observation information, as shown in FIG. 4.

Thus, the estimation unit 37 estimates a moving route of the vehicle based on the vehicle environmental information obtained by the wireless communication device 31.

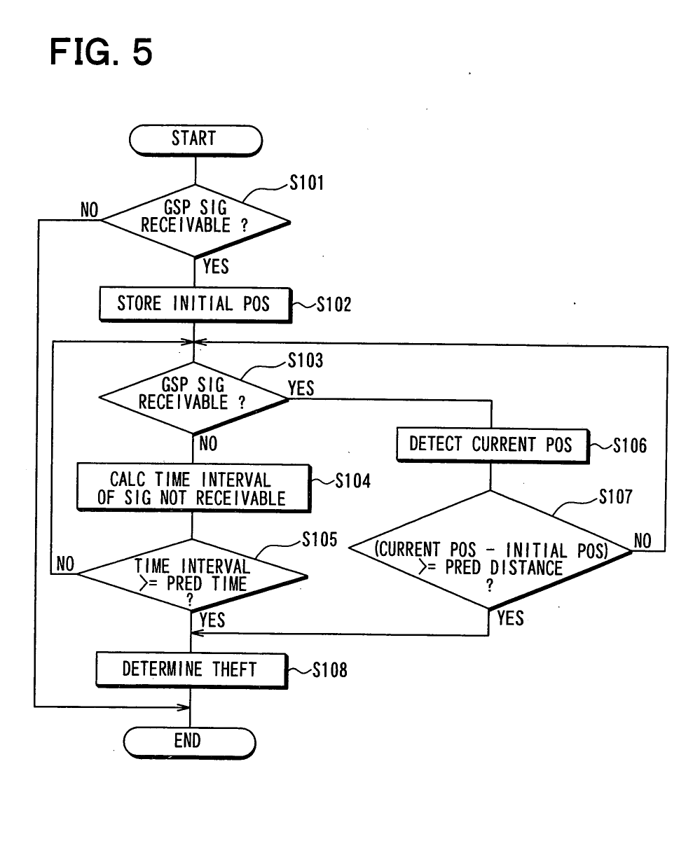

The process for tracking the position of the vehicle executed by the vehicle position tracking system will be explained with reference to FIGS. 5-7.

FIG. 5 shows a process for detecting theft of the vehicle executed by the controller 17. In the process, it is determined whether capability of detecting the position with using the GPS receiver 13. The process in FIG. 5 starts to be executed when an accessory power source of the vehicle turns off so that the in-vehicle device 10 is operated after the user of the vehicle parks at a parking lot. Alternatively, the user may operate a power source switch of the in-vehicle device 10 so that the device 10 starts' the operation.

In step S101, the controller 17 determines whether the GPS receiver 13 can receive a predetermined number of the GPS signals, which is required to detect the current position of the vehicle. Specifically, when the GPS receiver 13 receives three or more GPS signals from the GPS satellites, the GPS receiver 13 can detect the current position of the vehicle. In step S101, when the controller 17 determines that the GPS receiver 13 can detect the current position of the vehicle based on the GPS signals, it goes to step S102. When the controller 17 determines that the GPS receiver 13 cannot detect the current position of the vehicle since the GPS receiver 13 cannot receives the GPS signals, the controller 17 ends the process for detecting theft of the vehicle.

In step S102, the positioning information of the initial position at which the user parks the vehicle is stored. Here, the positioning information of the initial position is obtained by the GPS receiver 1. Then, it goes to step S103. In step S103, similar to step S101, the controller 17 determines whether the GPS receiver 13 can receive a predetermined number of the GPS signals, i.e., the controller 17 determines whether the current position of the vehicle is detectable. In step S103, when the controller 17 determines that the current position of the vehicle is not detectable based on the GPS signals, it goes to step S104. When the controller 17 determines that the current position of the vehicle is detectable based on the GPS signals, it goes to step S106.

In step S104, the controller 17 calculates an elapsed time since the GPS receiver 13 cannot receive the GPS signals. Specifically, the controller 17 calculates a time interval while the GPS signals are not receivable. Then, it goes to step S105. In step S105, the controller 17 determines whether the elapsed time exceeds a predetermined time. When the GPS signal interception time is equal to or larger than the predetermined time, it goes to step S108. In step S108, the controller 17 determines that the vehicle is stolen, i.e., the theft of the vehicle occurs. Then, the controller 17 ends the process in FIG. 5. When the GPS signal interception time is smaller than the predetermined time, it goes to step S103.

In step S106, the controller 17 obtains the positioning information of the current position of the vehicle detected by the GPS receiver 13 based on the GPS signals. Then, it goes to step S107. In step S107, the controller 17 compares the current position of the vehicle obtained in step S106 with the initial position of the vehicle at which the user parks the vehicle, which is stored in step S102. Further, the controller 17 determines whether a difference between the current position and the initial position exceeds a predetermined distance. When the controller 17 determines that the difference between the current position and the initial position exceeds the predetermined distance, it goes to step S108. In step S108, the controller 17 determines that the vehicle is stolen, i.e., the theft of the vehicle occurs. Then, the controller 17 ends the process in FIG. 5. When the controller 17 determines that the difference between the current position and the initial position does not exceed the predetermined distance, it goes to step S103.

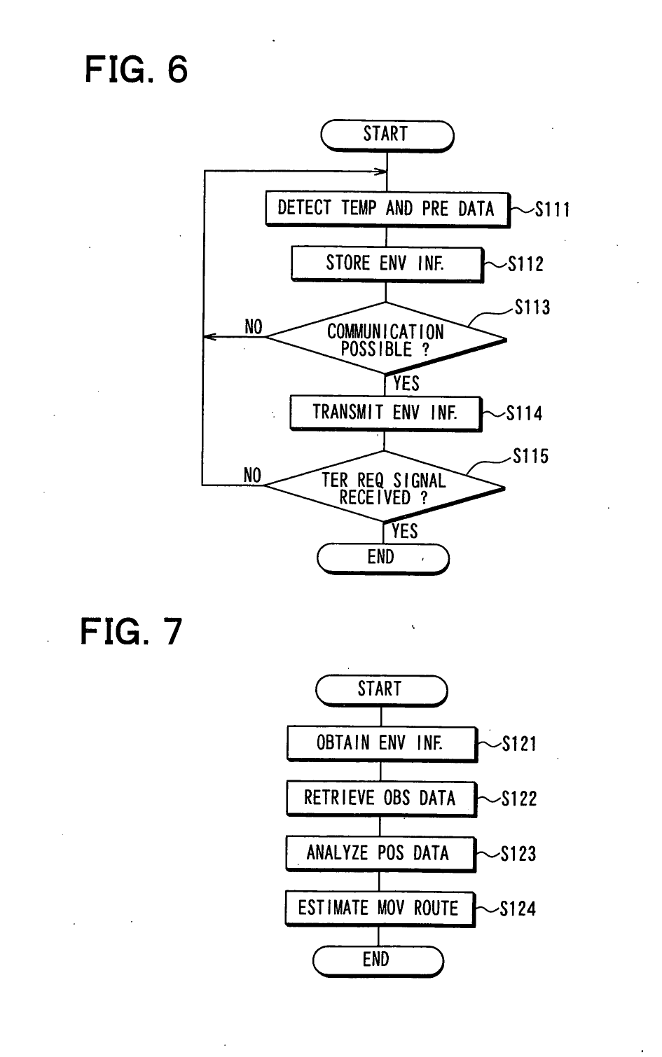

FIG. 6 is a process for transmitting the vehicle environmental information to the base station of the cell phone in the mobile communication network with using the in-vehicle device 10 executed by the controller 17. The process in FIG. 6 is executed when the controller determines in step S108 that the vehicle is stolen.

In step S111, the controller 17 obtains the detection data such as the temperature data and the atmospheric pressure data of the outside of the vehicle detected by the temperature sensor 15a and the atmospheric pressure sensor 15b. In addition, the detection time of the temperature data and the atmospheric pressure data is also obtained. The detection time is in association with the detection data. Then, it goes to step S112. In step S112, the temperature data, the atmospheric pressure data and the detection time data are stored as the vehicle environmental information in the memory 16. Then, it goes to step S113.

In step S113, the controller 17 determines whether the communication between the in-vehicle device 10 and the mobile communication network is possible, i.e., whether there is a base station of the cell phone, which the wireless communication device 11 can communicate with. When the controller 17 determines that the wireless communication device 11 can communicate with the base station in the mobile communication network, it goes to step S114. In step S114, the vehicle environmental information transmitted from the wireless communication device 11 to the base station of the cell phone. In-step S114, when there is the vehicle environmental information stored in the memory 16 that is not transmitted yet, the unsent vehicle environmental information together with the latest vehicle environmental information are also transmitted to the base station. Thus, in step S114 just after the communication is recovered, the unsent vehicle environmental information stored in the memory 16 while the communication between the wireless communication device 11 and the mobile communication network is interrupted is transmitted to the mobile communication network via the wireless communication device 11. When the controller 17 determines in step S113 that the communication between the in-vehicle device 10 and the mobile communication network is not possible, it goes to step S111.

In step S115, the controller 17 determines whether the wireless communication device 11 receives a request signal from the center device 30 or a terminal via the mobile communication network. The request signal provides to request termination of the transmission of the vehicle environmental information. When the wireless communication device 11 receives the request signal, the controller 17 ends the process for transmitting the vehicle environmental information. When the wireless communication device 11 does not receive the request signal, it goes to step S111.

In the above described process, when the GPS receiver cannot receive the GPS signals so that the GPS receiver 13 cannot detect the position of the vehicle based on the GPS signals from the GPS satellites, the controller 17 of the in-vehicle device 10 transmits the vehicle environmental information to the mobile communication network. In the first embodiment, the in-vehicle device 10 transmits the vehicle environmental information at predetermined time intervals such as one-minute intervals.

The vehicle environmental information transmitted to the mobile communication network in the process in FIG. 6 is received by the center device 30. FIG. 7 shows a process for estimating the moving route of the stolen vehicle executed by the estimation unit 37 of the center device 30. The estimation unit 37 starts to execute the process in FIG. 7 when the vehicle environmental information is received by the center device 30.

In step S121, the estimation unit 37 obtains the vehicle environmental information from the wireless communication device 31 via the mobile communication network. After the communication between the wireless communication device 11 in the in-vehicle device 10 and the mobile communication network is interrupted, and then, the communication is recovered, the estimation unit 37 obtains not only the latest vehicle environmental information but also the vehicle environmental information stored in the memory 16 while the communication is interrupted.

In step S122, based on the vehicle environmental information obtained in step S121, the estimation unit 37 retrieves the observation information in the database 36, which corresponds to the vehicle environmental information. Specifically, the estimation unit 37 retrieves the observation data from the database 36, the observation data corresponding to the temperature data and the atmospheric pressure data in the detection data and observed at the observation time corresponding to the detection time of the vehicle environmental information. The estimation unit 37 retrieves multiple observation data corresponding to multiple detection times from the database 36.

For example, when the detection time of the vehicle environmental information is at 12:00 shown as IIIA1 in FIG. 3, the estimation unit 37 retrieves the observation: information IVA2 in FIG. 4 that is observed at the observation time of 12:00 from the database 36. Based on the retrieved observation information, the temperature data and the atmospheric pressure data in the observation information IVA1 corresponding to the temperature data and the atmospheric pressure data in the vehicle environmental information are further retrieved from the observation information IVA2. In this case, the estimation unit 37 may verify the information about the base station of the cell phone network that receives the vehicle environmental information from the in-vehicle device 10 with the information attached to the observation information about the base station that is capable of communicating with the in-vehicle device 10, so that the verification is used for retrieving the observation information from the database 36. Thus, in step S122, the observation information is retrieved, and then, it goes to step S123.

The database 36 may store multiple observation data corresponding to the detection data of the vehicle environmental information. Specifically, in step S122, multiple observation information items corresponding to the vehicle environmental information may be retrieved. Thus, in step S123, when the estimation, unit 37 retrieves multiple observation data, and there are multiple observation information candidate items, the position data, i.e., the longitude and latitude data corresponding to each observation information candidate item is analyzed. Specifically, multiple position data corresponding to multiple detection times are analyzed. In step S124, based on the analysis in step S123, the position data in multiple observation information candidate items at each observation time corresponding to a respective detection time are arranged along with the observation time so that the estimated moving route provides a continuous trajectory. The estimated moving route providing the continuous trajectory provides a combination of the position data among multiple observation information candidate items at each observation time. Thus, in step S124, the combination of the observation information candidate items at multiple observation times is selected so as to form the continuous trajectory of the estimated moving route. Specifically, the selected multiple position data are arranged along with the observation time corresponding to the detection time so that the moving route is estimated. Thus, the moving route of the stolen vehicle is estimated, and the position of the vehicle is traced.

In the first embodiment, even when the reception condition of the GPS signals by the GPS receiver 13 is not good so that the position of the vehicle is not detected, if the communication between the wireless communication device 11 and the mobile communication network is possible, the in-vehicle device 10 can transmit the vehicle environmental information to the mobile communication network. The center device 30 estimates the moving route of the vehicle based on the vehicle environmental information transmitted from the in-vehicle device 10. Accordingly, even when the GPS receiver 13 cannot detect the position of the vehicle, the vehicle position tracking system estimates the moving route of the vehicle so that the system tracks the position of the vehicle.

Further, in the first embodiment, the center device 30 can obtain the vehicle environmental information, which is detected during the communication between the wireless communication device 11 and the mobile communication network is interrupted. Thus, the estimation unit 37 can estimate the moving route of the vehicle with using the latest vehicle environmental information and the vehicle environmental information, which is detected during the communication between the wireless communication device 11 and the mobile communication network is interrupted. Thus, the estimation unit 37 retrieves multiple observation data corresponding to the vehicle environmental information, which is detected at each detection time by the in-vehicle device 10. Thus, the estimation unit 37 obtains the position data corresponding to each observation data. Thus, even if the communication between the wireless communication device 11 and the mobile communication network is interrupted, the position data does not lack. The moving route estimated by the estimation unit 37 such that multiple position data are arranged along with the detection time has high accuracy. Accordingly, the vehicle position tracking system estimates the moving route of the vehicle with high accuracy, so that the system can track the position of the vehicle accurately.

In the first embodiment, the estimation unit 37 analyzes the position of the retrieved observation information so that the estimation unit 37 selects the combination of the position data so as to form the continuous trajectory, which provides the estimated moving route. This is because it is very possible that an actual moving route of the vehicle provides a continuous trajectory. Thus, the estimated moving route, which is obtained by arranging the position data along with the detection time, the position data being selected as the combination of the position data by the estimation unit 37, is substantially equal to the actual moving route of the vehicle with high accuracy. Thus, since the estimation unit 37 estimates the moving route with high accuracy, the position of the vehicle is accurately traced.

In the first embodiment, since the temperature and the atmospheric pressure provide information observed by a conventional metrological observation method, the observation data observed at various observation points is easily obtained. Thus, since the observation information obtained and stored in the database 36 is sufficiently large, the estimation unit 37 retrieves the observation data sufficiently corresponding to the detection data of the vehicle environmental information. Thus, when the position data of the observation point, at which the observation data is observed, is arranged along with the detection time, the moving route of the vehicle is estimated. The estimation of the moving route becomes much accurately. Accordingly, the vehicle position tracking system accurately tracks the position of the vehicle with using the estimated moving route.

In the first embodiment, the wireless communication device 11 and the wireless antenna 12 correspond to a communication element. The GPS receiver 13 and the GPS antenna 14 correspond to a GPS detector. The temperature sensor 15a, the atmospheric pressure sensor 15b and the controller 17 correspond to an environmental information obtaining element. The wireless communication device 31 and, the wireless antenna 32 correspond to a communication information obtaining element.

### Second Embodiment

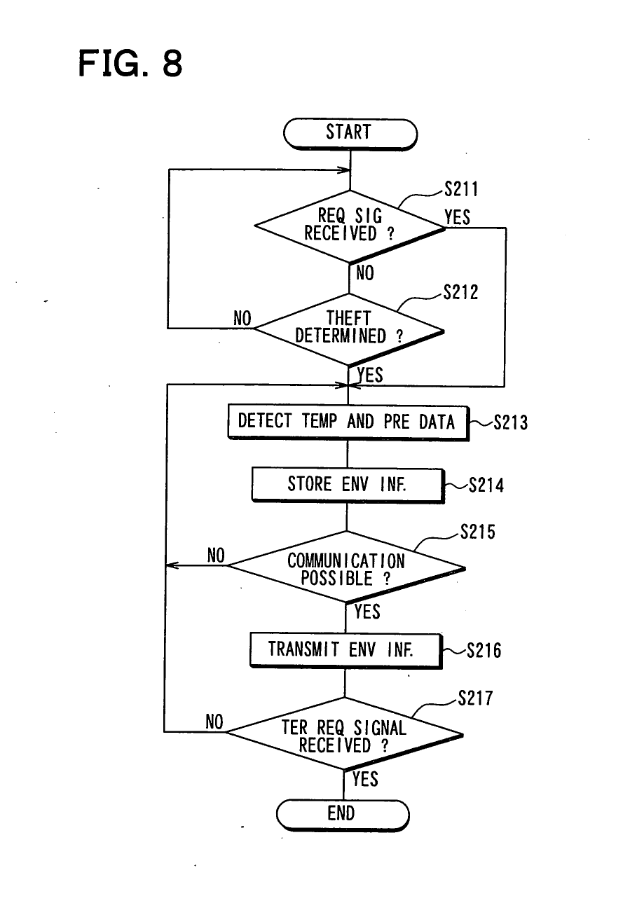

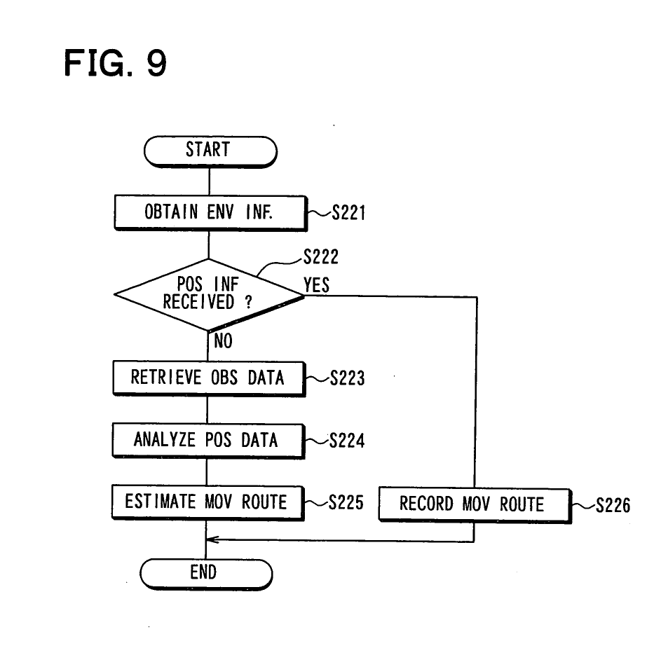

A vehicle position tracking system according to a second embodiment will be explained with reference to FIGS. 8 and 9. FIG. 8 shows a flowchart according to a modification of FIG. 6. Specifically, FIG. 8 shows a process for transmitting the vehicle environmental information from the controller 17 to the base station. In the first embodiment, the controller 17 starts to execute the process for transmitting the vehicle environmental information when the controller 17 determines in the process in FIG. 5 that the vehicle is stolen. In the second embodiment, the controller 17 starts to execute the process for transmitting the vehicle environmental information when the accessory power source of the vehicle turns off so that the in-vehicle device 10 is operated after the user of the vehicle parks at a parking lot. Alternatively, the user may operate a power source switch of the in-vehicle device 10 so that the device 10 starts the operation.

In the in-vehicle device 10 according to the second embodiment, the wireless communication device 11 can receive a request signal for requesting the transmission of the vehicle environmental information from the mobile communication network. When the wireless communication device 11 receives the request signal, the controller 17 transmits the vehicle environmental information obtained by the temperature sensor 15a and the atmospheric pressure sensor 15b with using the wireless communication device 11. Further, the controller 17 transmits the positioning information of the position of the vehicle detected by the GPS receiver 13 to the mobile communication network via the wireless communication device 11.

In the center device 30 according to the second embodiment the estimation unit 37 records the moving route of the stolen vehicle with using the positioning information when the wireless communication device 31 can obtain the positioning information. When the positioning information obtained by the wireless communication device 31 is not obtained, the estimation unit 37 estimates the moving route of the vehicle with using the position data in the observation information retrieved according to the vehicle environmental information.

The process for transmitting the vehicle environmental information by the controller 17 in the in-vehicle device 10 according to the second embodiment will be explained.

In step S211, the controller 17 determines whether the wireless communication device 11 receives the request signal for requesting to start the transmission of the vehicle environmental information via a terminal, which is capable of communicating with the center device 30 or the mobile communication network. When the wireless communication device 11 receives the request signal, it goes to step S213. In step S213, the controller 17 starts to obtain the vehicle environmental information. When the wireless communication device 11 does not receive the request signal, it goes to step S212.

In step S212, the controller 17 determines whether the vehicle is stolen, i.e., whether the theft determination is executed in step S108 in FIG. 5. When the controller 17 determines that the theft determination is executed, it goes to step S213. When the controller 17 determines that the theft determination is not executed, it goes to step S211. Steps S213 to S217 correspond to steps S111 to S115, respectively. In step S213, the controller 17 obtains the vehicle environmental information such as the temperature data, the atmospheric pressure data and the detection time of the outside of the vehicle. Then, it goes to step S214. In step S214, the vehicle environmental information is stored in the memory 16. Then, it goes to step S215. In step S215, the controller 17 determines whether the communication between the in-vehicle device 10 and the mobile communication network is possible. When the controller 17 determines that the wireless communication device 11 can communicate with the base station in the mobile communication network, it goes to step S216. In step S216, the latest vehicle environmental information together with the unsent vehicle environmental information are transmitted from the wireless communication device 11 to the base station of the cell phone. When the controller 17 determines in step S215 that the communication between the in-vehicle device 10 and the mobile communication network is not possible, it goes to step S213. In step S217, the controller 17 determines whether the wireless communication device 11 receives a request signal for requesting termination of the transmission of the vehicle environmental information. When the wireless communication device 11 receives the request signal, the controller 17 ends the process for transmitting the vehicle environmental information. When the wireless communication device 11 does not receive the request signal, it goes to step S213.

In the second embodiment, a process for estimating and recording a moving route of the stolen vehicle will be explained. The process is executed by the estimation unit 37 of the center device 30.

In step S221, similar to step S121, the estimation unit 37 obtains the vehicle environmental information via the wireless communication device 31 and the mobile communication network. It goes to step S222. In step S222, the estimation unit 37 determines whether the positioning information together with the vehicle environmental information is transmitted from the in-vehicle device 10. In step S222, when the estimation unit 37 determines that the positioning information is not transmitted from the in-vehicle device 10, steps S223 to S225 are executed, and then, the estimation unit 37 ends the process in FIG. 9. Steps S223 to S225 correspond to steps S122 to S124, respectively. In step S223, the estimation unit 37 retrieves the observation information in the database 36, which corresponds to the vehicle environmental information. Then, it goes to step S224. In step S224, the position data, i.e., the longitude and latitude data corresponding to each observation information candidate item is analyzed. In step S225, based on the analysis in step S224, the moving route of the stolen vehicle is estimated, and the position of the vehicle is traced.

In step S222, when the estimation unit 37 determines that the positioning information is transmitted from the in-vehicle device 10, the estimation unit 37 obtains the position information, and then, it goes to step S226. In step S226, based on the position information, the moving route of the stolen vehicle is recorded, and then, the estimation unit 37 ends the process in FIG. 9.

In the second embodiment, when the wireless communication device 11 receives the request signal for requesting the transmission of the vehicle environmental information via the mobile communication network, the controller 17 transmits the vehicle environmental information to the mobile communication network via the wireless communication device 11. Thus, for example, when it is determined that the vehicle is stolen, the center device 30 can start to obtain the vehicle environmental information before the GPS receiver 13 cannot detect the position of the vehicle. Thus, since the center device 30 can obtain a lot of vehicle environmental information, the center device 30 can estimate the moving route of the vehicle much accurately.

Further, in the second embodiment, when the in-vehicle device 10 starts to transmit the vehicle environmental information according to the request signal, it is considered that the in-vehicle device 10 can detect the position of the vehicle with using the GPS receiver 13. Thus, the positioning information of the position of the vehicle detected by the GPS receiver 13 together with the vehicle environmental information are transmitted to the mobile communication network via the wireless communication device 11. The center device 30 can obtain the accurate positioning information.

The estimation unit 37 of the center device 30 records the actual moving route of the vehicle based on the positioning information when the estimation unit 37 obtains the positioning information. When the wireless communication device 31 cannot receive the positioning information, the estimation unit 37 estimates the moving route of the vehicle with using the position data of the retrieved observation data corresponding to the vehicle environmental information. Thus, the estimation unit 37 can obtain the moving route of the vehicle accurately and surely with using a combination of the positioning information and the vehicle environmental information.

Accordingly, the vehicle position tracking system according to the second embodiment tracks the position of the vehicle accurately and surely according to the estimated moving route and the recorded moving route.

### Other Embodiments

In the above embodiments, the meteorological data used for estimating the moving route of the vehicle is the temperature data and the atmospheric pressure data. Alternatively, other data may be used as the meteorological data as long as the meteorological data can be obtained at multiple observation points, and the center device 30 can obtain the meteorological data even when the GPS signal is not received by the in-vehicle device 10. For example, humidity data and geomagnetic data may be used as the meteorological data. In addition, a combination of these data may be appropriately selected.

In the above embodiments, the in-vehicle device 10 includes the memory 16, so that the memory 16 stores the vehicle environmental information while the communication between the mobile communication network and the in-vehicle device 10 is interrupted. After the communication between the mobile communication network and the in-vehicle device 10 is recovered, the unsent vehicle environmental information is transmitted to the center device 30. Alternatively, the in-vehicle device 10 may not include the memory 16. Further, the memory 16 may have a small storage capacity so that the memory 16 stores only the recent vehicle environmental information, and the old vehicle environmental information is deleted in a chronological order. Further, the unsent vehicle environmental information may be not deleted.

In the above embodiments, the position data of the observation data retrieved at each detection time, is analyzed, so that the estimated moving route becomes the continuous trajectory. Thus, the estimation of the moving route by the estimation unit 37 is improved. Alternatively, the estimation unit 37 may not take the relationship of multiple position data at every detection times into account, but the estimation unit 37 may retrieve each observation data and the respective position data corresponding to the vehicle environmental information at each detection time. Thus, when the position data is retrieved individually, and the moving route of the vehicle is estimated, the vehicle position tracking system can track the position of the stolen vehicle.

In the above embodiments, the controller 17 includes a micro computer having the ROM and the RAM. The estimation unit 37 provides the functional unit for executing the program with using the calculator. The controller and the estimating element may be performed by a special micro computer for the controller 17 or the functional unit in the calculator such as the estimation unit 37. Alternatively, the controller and the estimation unit 37 may be provided by an electric circuit.

In the above embodiments, the in-vehicle device 10 for transmitting the vehicle environmental information is mounted on the vehicle. Alternatively, the functions of the in-vehicle device 10 may be provided by an in-vehicle navigation device. The navigation device includes a function corresponding to the GPS receiver 13. Further, a certain navigation device is capable of the bi-directional communication with the mobile communication network via a cell phone or the like. Thus, when the navigation device has a function corresponding to the in-vehicle device, the theft vehicle tracking system becomes common.

The above disclosure has the following aspects.

According to an aspect of the present disclosure, a vehicle position tracking system for tracking a position of a vehicle includes: an in-vehicle device mounted on the vehicle; and a center device mounted in an external center. The in-vehicle device transmits information to the center device via a mobile communication network so that the center device tracks the position of the vehicle. The in-vehicle device includes: a GPS detector for detecting a vehicle position of the vehicle based on a GPS signal from a GPS satellite; an environmental information obtaining element for obtaining environmental information, which includes a plurality of meteorological data of an outside of the vehicle as detection data and a plurality of detection time data, wherein each meteorological data corresponds to a respective detection time data; a communication element for communicating with the mobile communication network; and a controller for controlling the communication element to transmit the environmental information when reception of the GPS signal via the GPS detector is interrupted. The center device includes: a communication information obtaining element for obtaining the environmental information from the in-vehicle device via the mobile communication network; a database for obtaining observation information and for storing the observation information at every time when the database obtains the observation information, wherein the observation information includes a plurality of meteorological data observed at each of a plurality of observation points as observation data, a plurality of observation time data and observation position data of a respective observation point, and wherein each meteorological data at a respective observation point corresponds to a respective observation time data; and an estimation unit for estimating a moving route of the vehicle based on the environmental information. The estimation unit retrieves a plurality of observation data with a plurality of observation time data in such a manner that each observation data corresponds to respective detection data, each observation time data corresponds to respective detection time data. The estimation unit arranges a plurality of observation position data corresponding to a plurality of retrieved observation data in a chronological order so that the estimation unit estimates the moving route of the vehicle.

In the above system, even when the GPS detector cannot receive the GPS signal so that the GPS detector does not detect the position of the vehicle, if the communication between the communication element and the mobile communication network is possible, the in-vehicle device transmits the environmental information to the mobile communication network. The center device can estimate the moving route of the vehicle based on the environmental information. Accordingly, even when the GPS detector cannot detect the position of the vehicle, the system can track the position of the vehicle with using the estimated moving route of the vehicle.

Alternatively, the in-vehicle device may further include a memory for storing the environmental information. The controller controls the communication element to transmit latest environmental information together with unsent, environmental information to the mobile communication network when communication between the communication element and the mobile communication network is recovered after the communication between the communication element and the mobile communication network is interrupted. The memory stores the unsent environmental information while the communication between the communication element and the mobile communication network is interrupted. The estimation unit estimates the moving route of the vehicle based on the latest environmental information and the unsent environmental information. In this case, the center device can obtain the unsent environmental information. Thus, the estimation unit surely retrieves the observation data based on the latest environmental information and the unsent environmental information. Since lack of the position data is reduced, the estimated moving route is much accurately obtained. Thus, the system tracks the position of the vehicle accurately.

Alternatively, the estimation unit may retrieve a plurality of observation data candidate items corresponding to each detection data. The estimation unit analyzes a plurality of observation position data of the plurality of observation data candidate items so that the estimation unit selects one of the plurality of observation position data so as to provide an estimated moving route of the vehicle to be a continuous trajectory, and the estimation unit arranges a plurality of selected observation position data in a chronological order so that the estimation unit estimates the moving route of the vehicle. In this case, the estimation unit selects one of the plurality of observation position data so as to provide an estimated moving route of the vehicle to be a continuous trajectory because the actual moving route of the vehicle provides a continuous trajectory. Thus, the estimated moving route is almost the actual moving route of the vehicle with high accuracy. Thus, the system tracks the position of the vehicle accurately.

Alternatively, the communication element may receive a request signal from the mobile communication network. The request signal requests to transmit the environmental information, and the controller controls the communication element to transmit the environmental information to the mobile communication network when the communication element receives the request signal. In this case, when it is determined that the vehicle is stolen, the center device can start to obtain the environmental information before the GPS detector cannot detect the position of the vehicle. Thus, since the center device can obtain much environmental information, the center device can estimate the moving route much accurately. Thus, the system tracks the position of the vehicle accurately.

Alternatively, the controller may control the communication element to transmit the environmental information together with information of the vehicle position to the mobile communication network. The estimation unit records the information of the vehicle position when the communication information obtaining element obtains the information of the vehicle position from the in-vehicle device via the mobile communication network, and the estimation unit estimates the moving route based on the plurality of observation position data corresponding to the plurality of retrieved observation data when reception of the information of the vehicle position via the communication information obtaining element is interrupted. In this case, when the in-vehicle device starts to transmit the environmental information according to the request signal, it is considered that the GPS detector can detect the position of the vehicle. Thus, when the position information together with the environmental information is transmitted to the mobile communication network via the communication element, the center device can obtain the accurate position of the vehicle. When the reception of the information of the vehicle position via the communication information obtaining element is interrupted, the estimation unit estimates the moving route based on the plurality of observation position data corresponding to the plurality of retrieved observation data. Thus, both of the position information and the environmental information are used for tracking the position of the vehicle, so that the estimation unit can obtain the moving route of the vehicle accurately and surely.

Alternatively, the meteorological data may be at least one of temperature data, humidity data and atmospheric pressure data. Since the temperature and the atmospheric pressure and the humidity provide information observed by a conventional metrological observation method, the observation data observed at Various observation points is easily obtained. Thus, since the observation information obtained and stored in the database is sufficiently large, the estimation unit retrieves the observation data sufficiently corresponding to the detection data of the vehicle environmental information. Thus, when the position data of the observation point, at which the observation data is observed, is arranged along with the detection time, the moving route of the vehicle is estimated. The estimation of the moving route becomes much accurately. Accordingly, the vehicle position tracking system accurately tracks the position of the vehicle with using the estimated moving route.

Alternatively, the environmental information obtaining element may include at least one of a temperature sensor for detecting temperature of an outside of the vehicle, an atmospheric pressure sensor for detecting atmospheric pressure of the outside of the vehicle and a humidity sensor for detecting humidity of the outside of the vehicle, and the observation data is observed by at least one of a temperature sensor for detecting temperature of a respective observation point, an atmospheric pressure sensor for detecting atmospheric pressure of the respective observation point, and humidity sensor for detecting humidity of the respective observation point.

Alternatively, the estimation unit may retrieve the plurality of observation data with the plurality of observation time data in such a manner that each observation data is disposed within a predetermined deviation from respective detection data, each observation time data is equal to respective detection time data. The environmental information obtaining element obtains environmental information at predetermined time intervals, and the observation data is observed at the predetermined time intervals.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or, only a single element, are also within the spirit and scope of the invention.

What is claimed is:

1. A vehicle position tracking system for tracking a position of a vehicle comprising:
an in-vehicle device mounted on the vehicle; and
a center device mounted in an external center,
wherein the in-vehicle device transmits information to the center device via a mobile communication network so that the center device tracks the position of the vehicle,
wherein the in-vehicle device includes:
a GPS detector for detecting a vehicle position of the vehicle based on a GPS signal from a GPS satellite;
an environmental information obtaining element for obtaining environmental information, which includes a plurality of meteorological data of an outside of the vehicle as detection data and a plurality of detection time data, wherein each meteorological data corresponds to a respective detection time data,
a communication element for communicating with the mobile communication network; and
a controller for controlling the communication element to transmit the environmental information when reception of the GPS signal via the GPS detector is interrupted,
wherein the center device includes:
a communication information obtaining element for obtaining the environmental information from the in-vehicle device via the mobile communication network;
a database for obtaining observation information and for storing the observation information at every time when the database obtains the observation information, wherein the observation information includes a plurality of meteorological data observed at each of a plurality of observation points as observation data, a plurality of observation time data and observation position data of a respective observation point, and wherein each meteorological data at a respective observation point corresponds to a respective observation time data; and
an estimation unit for estimating a moving route of the vehicle based on the environmental information,
wherein the estimation unit retrieves a plurality of observation data with a plurality of observation time data in such a manner that each observation data corresponds to respective detection data, each observation time data corresponds to respective detection time data, and
wherein the estimation unit arranges a plurality of observation position data corresponding to a plurality of retrieved observation data in a chronological order so that the estimation unit estimates the moving route of the vehicle.

2. The vehicle position tracking syStem according to claim 1,
wherein the in-vehicle device further includes a memory for storing the environmental information,
wherein the controller controls the communication element to transmit latest environmental information together with unsent environmental information to the mobile communication network when communication between the communication element and the mobile communication network is recovered after the communication between the communication element and the mobile communication network is interrupted,
wherein the memory stores the unsent environmental information while the communication between the communication element and the mobile communication network is interrupted, and
wherein the estimation unit estimates the moving route of the vehicle based on the latest environmental information and the unsent environmental information.

3. The vehicle position tracking system according to claim 1,
wherein the estimation unit retrieves a plurality of observation data candidate items corresponding to each detection data,
wherein the estimation unit analyzes a plurality of observation position data of the plurality of observation data candidate items so that the estimation unit selects one of the plurality of observation position data so as to provide an estimated moving route of the vehicle to be a continuous trajectory, and
wherein the estimation unit arranges a plurality of selected observation position data in a chronological order so that the estimation unit estimates the moving route of the vehicle.

4. The vehicle position tracking system according to claim 1,
wherein the communication element receives a request signal from the mobile communication network,
wherein the request signal requests to transmit the environmental information, and
wherein the controller controls the communication element to transmit the environmental information to the mobile communication network when the communication element receives the request signal.

5. The vehicle position tracking system according to claim 4,
wherein the controller controls the communication element to transmit the environmental, information together with information of the vehicle position to the mobile communication network,
wherein the estimation unit records the information of the vehicle position when the communication information obtaining element obtains the information of the vehicle position from the in-vehicle device via the mobile communication network, and
wherein the estimation unit estimates the moving route based on the plurality of observation position data corresponding to the plurality of retrieved observation data when reception of the information of the vehicle position via the communication information obtaining element is interrupted.

6. The vehicle position tracking system according to claim 1,
wherein the meteorological data is at least one of temperature data, humidity data and atmospheric pressure data.

7. The vehicle position tracking system according to claim 6,
wherein the environmental information obtaining element includes at least one of a temperature sensor for detecting temperature of an outside of the vehicle, an atmospheric pressure sensor for detecting atmospheric pressure of the outside of the vehicle and a humidity sensor for detecting humidity of the outside of the vehicle, and
wherein the observation data is observed by at least one of a temperature sensor for detecting temperature of a respective observation point, an atmospheric pressure sensor for detecting atmospheric pressure of the respective observation point, and humidity sensor for detecting humidity of the respective observation point.

8. The vehicle position tracking system according to claim 7,
wherein the estimation unit retrieves the plurality of observation data with the plurality of observation time data in such a manner that each observation data is disposed within a predetermined deviation from respective detection data, each observation time data is equal to respective detection time data,
wherein the environmental information obtaining element obtains environmental information at predetermined time intervals, and
wherein the observation data is observed at the predetermined time intervals.
